(19) United States
(12) Patent Application Publication
(10) Pub. No.: US 2023/0038285 A1
(43) Pub. Date: Feb. 9, 2023

(54) STRIP AERATOR AND AERATOR ASSEMBLY

(71) Applicant: ARNOLD JÄGER HOLDING GMBH, Hanover (DE)

(72) Inventors: Philip BUHMANN, Braunschweig (DE); Hans-Christian VON CONSBRUCH, Hannover (DE); Sascha WINTER, Pattensen (DE); Christian LEMPFER, Rehburg (DE); Andreas JÄGER, Hannover (DE)

(21) Appl. No.: 17/790,353

(22) PCT Filed: Jan. 7, 2021
(86) PCT No.: PCT/EP2021/050187

§ 371 Date: Jun. 30, 2022

(30) Foreign Application Priority Data
Jan. 8, 2020 (EP) 20150764.7

(51) Int. Cl. B01F 23/231

(52) U.S. Cl. CPC B01F 23/231264; B01F 23/23124; B01F 23/231143; B01F 2101/305

(57) ABSTRACT

The invention relates to a strip aerator (1) for airing or gassing liquids, comprising an elastically deformable upper film section (3) having openings (6) for forming a flat membrane, and a through-opening (19) for the passing of a gas out of an inlet channel (21) into a gas-guiding chamber (5, 5a) that is bordered at the top by an upper film section (3) and at the bottom by an elastically deformable lower film section (4), the chamber being free from supporting bodies and/or supporting structures, the lower film section (4) being gas-tightly connected to the upper film section (3) such that an elastically deformable body is formed that is gas-tightly enclosed at the top and bottom by the film sections (3, 4), where lateral receiving regions (15) run at least at opposing sides (SL, SS) of the strip aerator (1) for connecting the strip aerator (1) to a retaining element (2), at least one of said film sections (3, 4) being connected to first securing means (8, 9) running, in certain regions or continuously, at least on those receiving regions (15).

The invention provides for the first securing means (8, 9) to be designed as a rod- or strip-shaped piping (Keder) (10) and having a round, oval, rectangular or square cross-section, or designed as mounting rails (11a, 12a) in the shape of a C profile or a piping profile (13).

The present invention relates to a strip aerator for aerating and gassing liquids according to the preamble of claim 1 as well as an aerator arrangement comprising at least one such strip aerator.

Strip aerators of this type or surface aerators serve, in particular, for aerating and gassing waste water as a liquid, where a planar membrane having a perforation or holes for creating a plurality of openings is provided. Through these openings gas can exit a gas-guiding chamber of the strip aerator so as to accordingly process the liquid or the waste water respectively.

A strip aerator of this type is known, for example, from the documents EP 1 545 753 B1, DE 10 2012 008 799 A1, DE 10 2012 009 282 A1, or DE 10 2012 008 800 A1. These strip aerators comprise an elongated rigid or non-elastic hollow profile corpus which defines a gas-guiding channel with open end faces. The hollow profile corpus has a rigid support wall which is designed as support surface for the gas-permeable or perforated membrane. In the support wall at least one through-opening is provided for passing a gas from the gas-guiding channel into an intermediate space formed between the support wall and the membrane as gas-guiding chamber from which the gas can exit in a controlled manner through the openings in the membrane. The open end faces of the gas inlet channel are closed in a gas-tight manner by closing elements.

This construction requires sophisticated seal profiles to be inserted laterally between the hollow profile corpus or the support wall respectively and the membrane and, moreover, the membrane has to be sealed at the end faces using sophisticated systems. To some extent it is required to resort to sealing compounds and adhesives to provide a long-term sealing of the system. Thus, it is quite costly to manufacture such a strip aerator with a support wall for supporting the perforated pierced membrane. Consequentially, the replacement of the membrane, e.g. in the context of maintenance, involves high cost.

Affixing such a strip aerator, e.g. to the clarification tank bottom, may be done in accordance with the citations AT 413 380 B or DE 10 2012 009 283 B4. To that end it is provided for each strip aerator merging into a pedestal region at the longitudinal edges of the hollow profile corpus, the pedestal region terminating in a receiving region having a foot flange angled towards the centre of the strip aerator in an L shape, and a mounting plate or, respectively, a retaining plate is provided the width of which is larger than the width of the strip aerator and which comprises connector means in its regions ging beyond the width of the strip aerator for connecting the retaining plate to the clarification tank bottom, whereby the retaining plate comprises engagement flanges complementary to the foot flanges that can be brought to engage with the foot flanges for affixing the strip aerator to the clarification tank bottom. This way, it is also possible to create aerator chains consisting of a plurality of strip aerators provided that the retaining plate has a length covering the distance between two strip aerators successive in the aerator chain.

It follows that the retaining plate as retaining element must be purposefully adapted to the respective rigid hollow profile corpus of the strip aerator so that each strip aerator requires an individually made holder.

Further strip aerators having a support corpus has been described, for example, in the documents US2015/001744 A1, WO 2018/146692A1, or WO 01/66474 A2. In addition, AT 391 126 B describes an aerator without a support corpus consisting of two sheet segments joined by a clamping strip which is affixed to a frame via loops. Further, WO 2007/051150 A2 describes an aerator without a support corpus which can be affixed to a bottom via ropes or a structural frame affixed to threaded rods. In the citations U.S. Pat. No. 3,642,260 and JP 6410443 B2 further means of attachment for an aerator without a support corpus are identified.

It is the object of the present invention to provide a strip aerator as well as an aerator arrangement that allows reliable operation despite being simple to manufacture, and which can be utilised in a flexible manner.

This task is solved according to the invention by a strip aerator according to claim 1 as well as an aerator arrangement according to the further independent claim. The sub-claims describe preferred further developments.

Thus, the invention provides that the at least one gas-guiding chamber of the strip aerator is bordered at the bottom, preferably completely, by at least one soft or elastically deformable lower film section, where the at least one lower film section is in a gas-tight manner to said an also soft or elastically deformable upper film section so the upper and lower film section forms a gas-tight enclosed elastically deformable body with a gas-guiding chamber in its interior, and the gas-tightly connected film sections between lateral receiving regions, which are arranged at opposite sides of the strip aerator, lie flat on top of one another, and/or one above the other, preferably completely, at least in part.

Hereby, the film sections are made, for example, from elastic plastics and may consist of the same or of different material(s) having the same or different degree(s) of harness.

This constitutes a further development of a strip aerator of the kind specified in the preamble in that this is independent from a non-elastic supporting basic corpus or support body which, as in the state of the art, is arranged inside gas-guiding chamber and limiting the same as part of the strip aerator and upon which the film sections may rest within or outside of operation of the strip aerator. Thus, advantageously, the upper film section as membrane does not require expensive sealing against a supporting basic corpus, e.g. via sealing profiles, so that sealing of the entire system is simplified.

This also makes the sealing more robust because it is at assembly already that the film sections are connected in a gas-tight manner and joined into an elastically deformable body, rather than making connections e.g. via sealing profiles later at the stage of mounting the strip aerator. This simplifies assembly altogether, whereby fixation can be realised on different support systems or mounting elements via the lateral receiving regions. This increases flexibility since the fixation no longer depends on a basic corpus planar holding or planar supporting the membrane which also holding the membrane in position against buoyancy in operation. Altogether, it is no longer required necessarily for the strip aerator to be in planar contact with a basic corpus. What is required is merely sufficient lateral support or anchoring of the elastically deformable body formed by the two film sections so as to maintain the strip aerator in position against the buoyancy when this is fed with gas in operation.

The replacement of the membrane, too, is simplified because the complete strip aerator may simply be removed from the retaining element and replaced entirely or cleaned in case of a defect or in the context of regular maintenance, without having to seal it again subsequently against a supporting basic corpus or the retaining element respectively. Thus, at most, a supporting retaining element is present which does not require costly sealing however.

The embodiment as independently ventilated elastically deformable body formed by the two film sections can be easily integrated into virtually any support systems. The strip aerator with the membrane can be removed from a support element very quickly so as to replace the strip aerator with the membrane; hereby, support systems or retaining elements may remain mounted at the bottom. Hereby, the function of the membrane or, respectively, the film sections is independent from the respective retaining element or support system respectively. This allows the use of most simple retaining elements upon which the strip aerator is mounted or, respectively, which hold the same. These retaining elements may be designed very flat and with little buoyancy and thus operate in an efficiency-optimised manner.

Moreover, owing to the elastically deformably designed film sections the strip aerator can be stored and transported in a space-saving manner, for example wound up on a roll. Thus, the strip aerator can be transported without retaining element or, respectively, the respective support system because it is independent from these. The installation of the strip aerator may happen after assembly of the retaining elements.

Let it be assumed that the strip aerator of the type described in the preamble is a surface aerator having at least one through-opening with a connecting channel for the passage of a gas from an inlet channel into at least one gas-guiding chamber, bordered at the top by the at least one upper film section, from which the gas can exit through the flat membrane into an environment. Hereby, the strip aerator comprises at least at opposite sides, i.e. laterally, preferably at least at the two longitudinal sides and/or also at the front face or faces, receiving regions extending or running in the longitudinal direction or, respectively, in perpendicular direction, so as to connect the strip aerator continuously or in certain regions to at least one retaining element to thereby anchor the strip aerator. Due to the elastic deformability the upper film section lies flat on the lower film section without applying gas pressure on the strip aerator or the gas-guiding chamber, i.e. drops down or collapses respectively. When gas pressure is applied the upper film section with the openings forming the membrane rises up from the lower film section.

Hereby, preferably, it may be provided for the at least one upper film section and the at least one lower film section to be designed as one piece or one part respectively, i.e. merging free from visible or invisible joints, where the film sections merge laterally (at the longitudinal sides and/or front faces) at the receiving regions. In the alternative, a two-piece design may be provided wherein the film sections are joined by positive locking and/or friction locking laterally or, respectively, at the longitudinal sides and/or front faces.

This allows a variable construction or, respectively, variable manufacturing of the strip aerator, where in the one-piece embodiment, e.g. as a tube, no additional sealing is required at the longitudinal sides or front faces respectively. In the two-piece embodiment it is preferably provided that the film sections are joined laterally (lengthwise and/or on the face side) in a joining region by means of adhesive bonding, welding, pressure die-casting or extruding. However, it is also possible for the gas-tight sealing at the front face (and, in principle, also at the longitudinal side) to be realised by means of an end profile or a clip capable of holding the film sections together in a gas-tight manner at the front face (or longitudinal side respectively).

For tethering the strip aerator to a retaining element, according to the invention, at least one of the film sections is connected to first securing means, which first securing means running in the receiving region in certain regions or continuously in the longitudinal direction and/or in perpendicular direction, depending on the type of tethering. Thereby, a safe hold can be guaranteed in operation of the strip aerator, whereby the invention provides for the purpose of easier assembly that the first securing means
are designed as a rod or strip, e.g. having a round or oval or rectangular or square-shaped or any other cross-section, in particular, in the form of a piping (Keder), or as
mounting rails, in particular, in the form of a C profile or a piping profile. Given sufficiently adjusted clearance, this allows them to be telescoped in the longitudinal direction or perpendicular direction respectively, so as to form a positive-locking connection, and, thus, to be assembled or disassembled respectively in a simple manner. Moreover, in an embodiment not claimed, hooks, bands, rings, screws, nails, or rivets or similar means can be used in the alternative as first securing means.

To support the first securing means it may be provided that these are attached to the lateral receiving regions by extrusion, adhesive bonding, flange-mounting, or at least one of the film sections is deformed on its edge in the way of a loop, e.g. clenched or constricted, such that receiving region is formed which surrounds the first securing means at least in part thereby retaining it. This can create a variable means of attachment.

Preferably, it may further be provided that the at least one upper film section and/or in in the at least one lower film section and/or at least at one face side between the at least one upper film section and the at least one lower film section a through-opening is arranged which is connected to the inlet channel, for example a pipe, preferably via a connecting channel, the connecting channel and/or the inlet channel in the region of the through-opening being attached to at least one of the film sections by positive locking and/or friction locking, for example bonded, welded, cramped or attached by means of a re-shaping process. This provides a simple and flexible manner to feed gas to the gas-guiding chamber.

In order to increase the surface of the strip aerator it may be additionally provided that the gas-guiding chamber formed between the film sections is sub-divided in partial chambers by intermediate connections extending in the longitudinal direction and/or in a perpendicular direction. This allows a strip aerator, the gas-guiding chamber of which usually has a length of at least 50 cm, preferably at least 200 cm, and a width of between 100 mm and 250 mm, to be designed longer or wider in that several of such chambers can be connected in series or in parallel in a daisy chain and/or side by side.

Further, an aerator arrangement including a strip aerator according to the invention as well as a retaining element is provided, wherein the strip aerator is attached, in total or in certain regions, to the retaining elements via the receiving regions extending or, respectively, running at least on opposite sides in the longitudinal direction and/or in perpendicular direction so that the gas-tightly connected film sections of the strip aerator between the lateral receiving regions lie flat on top of one another and/or one above the other, at least in part.

Hereby, it is provided that
the retaining element comprises second securing means in which the strip aearator is received in a slideable manner via the first securing means, where the first securing means are arranged laterally on the extended receiving regions, or
the retaining element is formed by spaced-apart bands or ropes to which the strip aerator is connected via the laterally arranged receiving regions in a manner slidably or fixed.

Further, it is provided that the first securing means
according to the invention, are designed as rods or strips having a round oval, rectangular or square cross-section, in particular, in the form of a piping (Keder), or
designed as mounting rails, in particular, in the shape of a C profile or a piping profile, where the first securing means are slidably received second in securing means designed correspondingly complementary, or
the first securing means are designed as means selected from a group consisting of: hook, band, ring, screw, nail, rivet, each penetrating the receiving region in receiving holes and being received at the retaining elements in a manner slidably or fixed.

Hereby, the strip aerator can be received in the retaining element in a manner fixed or slidably, depending on the type of fixation or securing means respectively.

The invention is further illustrated in the following by means of embodiment examples. It is shown in:

FIG. 1 a perspective view of an aerator arrangement including a strip aerator;

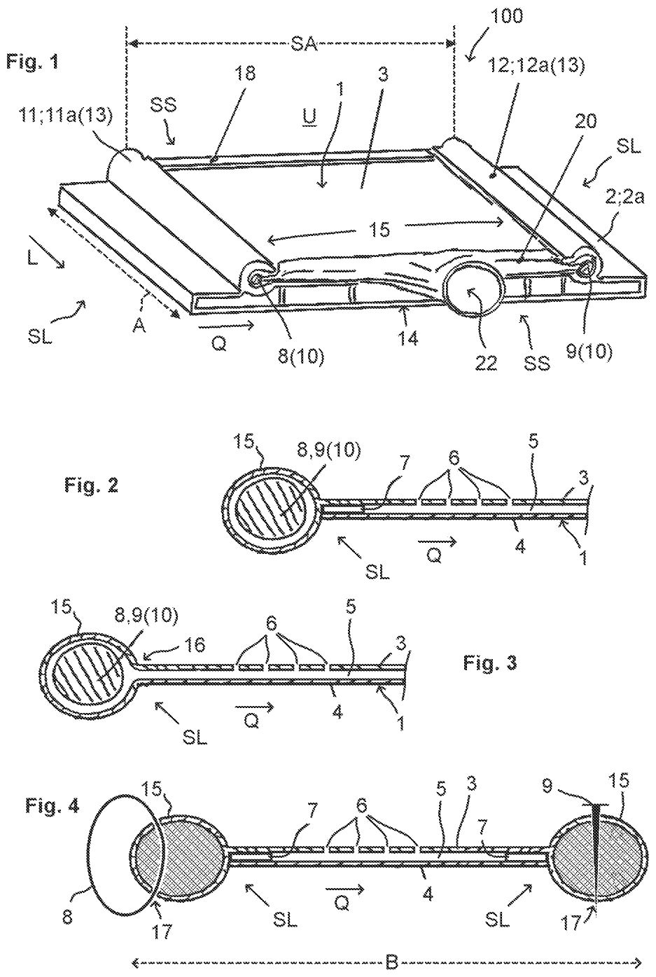

FIG. 2, 3, 4a sectional view through a receiving region of the strip aerator in different embodiments;

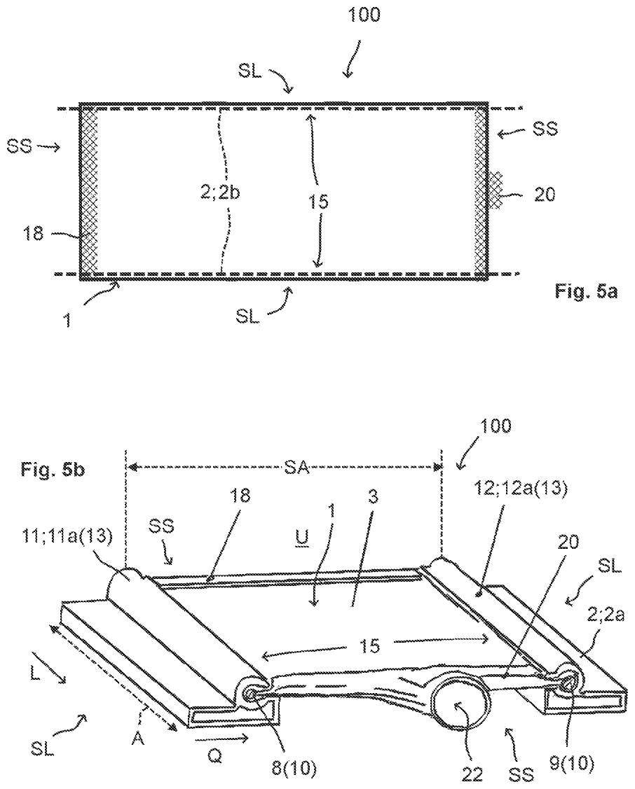

FIG. 5a, 5b further embodiments for retaining the strip aerator;

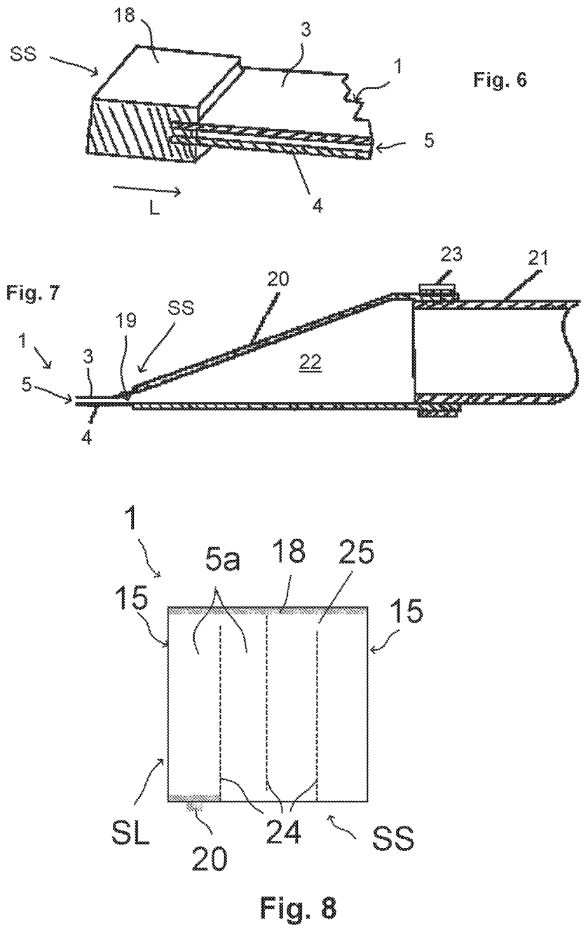

FIG. 6, 7 face side embodiments of the strip aerator; and

FIG. 8 the strip aerator in a further embodiment.

FIG. 1 shows a strip aerator 1 received at a retaining element 2 which, according to this embodiment, is designed as a retaining plate 2a. The aerator arrangement 100 consisting of the strip aerator 1 and the retaining plate 2a can be affixed to, for example, a bottom or a wall of a clarification tank or aeration tank respectively via connecting means or a frame (not shown) engaging with the retaining plate 2a.

According to the detailed view in FIG. 2 the strip aerator 1 comprises an upper film section 3 and a lower film section 4 which are gas-tightly joined at their longitudinal sides SL so that a gas-guiding chamber 5 is formed between them. When the strip aerator 1 is not in operation, i.e. is not actively perfused by gas, the two film sections 3, 4 lie flat on top of one another and/or one above the other, at least in part.

The upper film section 3 comprises a plurality of openings 6, e.g. slit-shaped holes, which may be introduced by means of perforating, punching, embossing, boring, lasering, water jetting, etc. and allow the passage of gas from the air-guiding chamber 5 into the environment U. In principle, the lower film section 4, too, may comprise such holes 6.

The film sections 3, 4 consist of a soft or elastically deformable material, preferably plastics. Depending on the embodiment, both film sections 3, 4 may be made of the same or different materials having the same of different degrees of hardness.

The longitudinal side connection between the film sections 3, 4 may be designed in various ways. Thus, it may be provided that both film sections 3, 4 after being manufactured are gas-tightly joined in a lateral joining region 7 by means of bonding, welding, pressure die-casting or extruding. Hereby, the openings 6 may be introduced into the upper film section 3 prior to the joining or thereafter. Moreover, it is possible for the two film sections 3, 4 to be designed as one piece or a single part respectively, for example in the form of an extruded elastically deformable tube with correspondingly thin wall thickness which will “collapse” when the strip aerator 1 is not in operation, so that the film sections 3, 4 lie flat on top of one another or at least one above the other, at least in part.

For connecting the strip aerator 1 to the retaining plate 2a the strip aerator 1 comprises first securing means 8, 9 on both sides in the region of the longitudinal sides SL in a receiving region 15 which serve to deflect the tensional load, acting on the strip aerator 1 in operation, to the retaining plate 2a. To allow consistent deflection to the retaining plate 2a the first securing means 8, 9 are arranged on both longitudinal sides SL distributed either throughout or in certain regions in the receiving regions 15, preferably along the entire length A of the strip aerator 1. In principle, it is possible for the strip aerator 1 to be attached to the retaining plate 2a in this way as an addition or alternatively on the face side, i.e. on one or both sides or in the region of its front faces SS, so as to deflect the acting tensional load to the retaining plate 2a and, additionally or alternatively, for the strip aerator 1 to be spanned at the front faces, i.e. in the perpendicular direction Q. Hereby, preferably, the length A of the strip aerator 1 is at least 0.5 m, preferably at least 2 m.

According to the embodiment in FIG. 1, the first securing means 8, 9 arranged on both sides are parts of the strip aerator 1 itself, with the first securing means 8, 9 being designed strip- or rod-shaped or, respectively, in the form or a piping (Keder) 10 and extend across the entire length A of the strip aerator 1. The respective first securing means 8, 9 may be connected to the longitudinal sides of the film sections 3, 4 in the receiving region 15, for example, by extruding, bonding, flanging, etc. First securing means 8, 9 so designed allow for a lateral reception of the strip aerator 1 by second securing means 11, 12, the second securing means 11, 12 in this embodiment being designed as mounting rails 11a, 12a in the manner of a Keder profile 13. To that end, the mounting rails 11a, 12a are affixed to the retaining plate 2a, preferably as an integral part of the retaining plate 2a.

Hereby, a rail spacing SA between the mounting rails 11a, 12a is chosen such that the film sections 3, 4 run with or without tensile stress between the mounting rails 11a, 12a when the strip aerator 1 is not in operation. Thus, a width B of the strip aerator 1 is a little larger or smaller than the rail spacing SA, the width B of the strip aerator 1 being, for example, between 100 mm and 250 mm. Hereby, the film sections 3, 4, in an intermediate region 14 between the mounting rails 11a, 12a, possibly lie in contact with the retaining plate 2a. When the strip aerator 1 is in operation at least the upper film section 3 or, respectively, the membrane becomes detached from the intermediate region 14 of the retaining plate 2a.

Instead of the rod-shaped first securing means 8, 9 with circular cross-section (Keder 10) first securing means 8, 9 having cuboid, oval, rectangular, semi-circular etc. circular cross-sections may be provided with a similar function, which are positive-locking received by correspondingly complementary designed mounting rails 11a, 12a, e.g. with a C profile, so as to hold the strip aerator 1 on both sides.

As shown in FIG. 2 and FIG. 3, the first securing means 8, 9 may also be retained at the strip aerator 1 in that one of both film section(s) 3, 4 in the receiving region 15 at the longitudinal sides SL, preferably along the entire length A of the strip aerator 1, is or are respectively deformed in the way of a loop. The first securing means 8, 9, in particular the Keder 10, is then positioned inside the so created loop or, respectively, surrounded by it. Hereby, in FIG. 2, the receiving region 15 is separate from the gas-guiding chamber 5. However, it is also possible for the first securing means 8, 9 in the receiving region 15 at the longitudinal sides SL SL, preferably along the entire length A of the strip aerator 1, is connected by extrusion clipping etc. (not shown).

When both film sections 3, 4 are designed as one piece or one part respectively it may be provided, according to FIG. 3, that the receiving region 15 is connected to the gas-guiding chamber via a narrow passage 16. In that case, the respectively selected first securing means 8, 9, e.g. the Keder 10, is to be inserted into the loop-type receiving region 15 and will be retained therein via the narrow passage 16 and/or a firmly bonded connection. In this embodiment, too, the respectively selected first securing means 8, 9 may be received in respectively associated mounting rail 11a, 12a in a firmly bonded manner, so as to retain the strip aerator 1.

In these embodiments, using a mounting rail 11a, 12a allows subsequent removal of the strip aerator 1 from the retaining plate 2a or, respectively, subsequent mounting of the strip aerator 1 at the retaining plate 2a and there with replacement in a simple manner. To that end, the first securing means 8, 9, in particular as Keder 10, are designed such that they are received with corresponding play in the respective mounting rail 11a, 12a so as to allow displacement in the longitudinal direction L.

In principle, it is also possible to arrange one mounting rail 11a, 12a each on both sides of the strip aerator 1 in the receiving region 15 as first securing means 8, 9, for example, joined in forming process, bonded, welded, joined by extrusion, flanged etc. Onto the retaining plate 2a strip-shaped or rod-shaped second securing means 11, 12 e.g. in the form of piping 10 are attached in such a way that the strip aerator 1 can be slid onto the piping 10 in the longitudinal direction L with the mounting rails 11a, 12a on both sides, so as to create the firmly bonded connection. In that case, the securing means 8, 9 would be reversed compared to the embodiment with the securing means 11, 12 shown in FIG. 1.

In principle, the strip aerator 1 may be retained also via a differently designed receiving region 15 on both sides at the retaining plate 2a. When the gas-guiding chamber 5 is gas-tightly separated by any means from the receiving region 15, the receiving region 15 may, for example, be penetrated by receiving holes 17 with or without protective eyelets. For example, it is possible to insert or introduce respectively hooks, rings, bands, screws, rivets or similar into the receiving holes 17 as first securing means 8, 9. Because in this embodiment the receiving region 15 is separate from the gas-guiding chamber 5 the tightness of the gas-guiding chamber 5 will not be compromised thereby.

For example, the rings, bands, or hooks Haken (see FIG. 4 left side) may be received permanently or removably in the receiving holes 17 as first securing means 8, 9 and by attached in any manner to the retaining plate 2a, likewise, permanently or removably. Further, the receiving region 15 may be penetrated by screws, nails or rivets (comp. FIG. 4 right side) as first securing means 8, 9 so that the receiving holes 17 will form therein subsequently upon being introduced. In that case, the screws, nails or rivets will be correspondingly also screwed-in or otherwise received respectively in the retaining plate 2a.

In principle, suitably designed first securing means 8, 9 may also be affixed to the lateral receiving regions 15 of the strip aerator 1 by other means, for example, clamped from outside, bonded or welded, without compromising the tightness of the gas-guiding chamber 5.

Instead of a retaining plate 2a as retaining element 2, in connection with such first securing means 8, 9 penetrating the receiving region 15 or otherwise affixed thereto, according to FIG. 5a, for example, bands or ropes 2b braced in the clarification tank may be provided as retaining element 2. These can retain, as parallel running bands or ropes 2b respectively, the first securing means 8, 9 received on both sides in the receiving region 15 or affixed thereto respectively so that the gas-tightly connected film sections 3, 4 can be held in position between the bands or ropes 2b respectively. In that case, an intermediate region 14 supporting the film sections 3, 4 is no longer provided, whereby this is actually not required in the construction of the strip aerator 1 according to the invention.

As a further development it may be provided that the bands or ropes 2b respectively run through the receiving region 15 as retaining elements 2 and/or are attached thereto frictionally engaged or by positive locking or firmly bonded respectively so that the strip aerator 1 can be removed from the clarification tank or, respectively, immersed therein by pulling the ropes 2b. In this case a first securing means 8, 9 for securing the strip aerator 1 to the retaining element 2 is not absolutely necessary or, respectively, this is achieved by the friction-locked and/or firmly bonded connection.

Moreover, instead of a planar retaining plate 2a with integrated mounting rails 11a, 11b (s. FIG. 1), it is possible to provided merely two separate mounting rails 11a, 11b, as shown in FIG. 5b. These may be affixed, for example, to the clarification tank or a frame and serve to retain the strip aerator 1. In that case, in contrast to FIG. 1, an intermediate region 14 supporting the film sections 3, 4 is no longer provided, whereby this is actually not required in the construction of the strip aerator 1 according to the invention.

In order to seal the two film sections 3, 4 in a completely gas-tight manner and therewith to make sure that gas can exit from the gas-guiding chamber 5 only through the openings 6 in the upper film section 3, the film sections 3, 4 are also gas-tightly joined at their front faces SS. This face side connection may be realised, in a manner similar to the connection at the longitudinal sides SL, by means of bonding or welding or pressure die-casting and/or via an additional end profile 18 as closing element which, as shown in FIG. 6, can be added in a forming process, e.g. in a plastics or rubber press, and encapsules the two film sections 3, 4 in-between in a gas-tight manner. This end profile 18 may be created, with similar effect, also by bonding, lasering, tensioning, welding or screwing two bars or a clip respectively.

Thus, it is possible to gas-tightly close one or both end faces SS of the film sections 3, 4 or, respectively, of the strip aerator 1 in any of these ways.

In order to be able to pressurise the gas-tight chamber 5 with the gas, the strip aerator 1 according to FIG. 7 is provided at one of the end faces SS with at least one through-opening 19 having a connecting channel 20 for receiving e.g. a pipe 21 (inlet channel). Hereby, in principle, the through-opening 19 with the connecting channel 20 may be provided in the upper film section 3 (not shown), in the lower film section 4 (not shown) or at the end face, as shown in FIG. 7. It may also be provided to bond, weld, clamp, etc. the pipe 21 directly to the film sections 3, 4 thereby creating a gas-tight connection. Thus, the pipe 21 as inlet channel then replaces the connecting channel 20.

For creating a front face connecting channel 20 it may be provided, for example, to insert the film sections 3, 4, which are laterally gas-tightly connected but still open at the end face (on one or both sides), into a plastics- or rubber press and to attach an expanding opening 22 via a forming tool with core to the film sections 3, 4, having a through-opening 19 at their end face, in a forming process. Preferably, the material of the connecting channel 20 attached in the forming process is the same or a similar material as that of the film sections 3, 4, however, it may consist of another material. Subsequently, the pipe 21 can be inserted into the connecting channel 20 and secured e.g. by means of clips 23 so that gas can be fed in via the pipe 21 as inlet channel.

Such an end face connecting channel 20 may also be provided on both end faces SS of the film sections 3, 4, for example, in order to be able to create an aerator chain made up of a plurality of such strip aerators 1. However, it is also possible to combine and end face connecting channel 20 with a connecting channel 20 disposed at the upper and/or lower film section 3, 4 for creating a chain of aerators.

In the alternative or as an addition, it may be provided for airing a larger area that a plurality of gas-guiding partial chambers 5a is formed between two film sections 3, 4. According to FIG. 8, this can be achieved, for example, in that the gas-guiding chamber 5 formed between the film sections 3, 4 is sub-divided by interconnections 24 extending in the longitudinal direction L and/or in perpendicular direction Q. The plurality of partial chambers 5a so created may be pressurised with gas via separate connecting channels 20 from the outside and/or in that the interconnections 24 have gaps in certain areas so as to create through channels 25 between the individual partial chambers 5a. In that case, all partial chambers 5a may be pressurised with gas via merely one connecting channel 20 or, depending on the surface of the sub-divided strip aerator 1, also via further connecting channels 20.

According to the invention, this provides a strip aerator 1 comprising:
the at least two gas-tightly interconnected film sections 3, 4 for creating the gas-guiding chamber 5 or the partial chambers 5a,
the lateral receiving regions 15 for connecting the strip aerator 1 to one or more retaining elements 2, as well as
at least one connecting channel 20.

Thus, a basic corpus or support body or support wall respectively is no longer provided in the gas-guiding chamber 5 or in the partial chambers 5a themselves. The intermediate region 14 in the embodiment according to FIG. 1 is merely caused by the planar shape of the retaining plate 2a, with the function of the strip aerator 1 being totally independent from the supporting effect of the retaining plate 2a and any other support bodies, too. Thus, the strip aerator 1 may be realised without support system flat and with little buoyancy (and thereby efficiency-optimised). Due to its elastic flexibility, the disassembled strip aerator 1 may, for example, be wound up in the longitudinal direction L so as to save space, making it easier to transport and store it.

### LIST OF REFERENCE NUMERALS

1 strip aerator
2 retaining element
2a retaining plate
2b rope/band
3 upper film section
4 lower film section
5 gas-guiding chamber
5a gas-guiding partial chamber
6 openings
7 joining region
8, 9 first securing means
10 piping (Keder)
11, 12 second securing means
11a, 12a mounting rail
13 Keder profile
14 intermediate region
15 receiving region
16 narrow passage
17 receiving holes
18 end profile
19 through-opening
20 connecting channel
21 pipe (inlet channel)
22 expanding opening
23 clip
24 interconnection
25 passing channel
100 aerator arrangement
A length of the strip aerator 1
SA rail spacing
B width of the strip aerator 1
L longitudinal direction
SL longitudinal side
SS front face
U environment

1. A strip aerator for airing or gassing liquids, in particular waste water, comprising at least one elastically deformable upper film section having openings for forming a flat membrane, and a through-opening with a connecting channel for the passing of a gas out of an inlet channel into at least one gas-guiding chamber that is bordered at the top by said at least one upper film section, from which the gas can exit through the flat membrane onto an environment,
wherein lateral receiving regions run at least on opposite sides of the element aerator in order to attach the strip aerator to at least one retaining element, said at least one gas-guiding chamber being bordered at the bottom by at least one elastically deformable lower film section, said at least one lower film section being connected in a gas-tight manner to said at least one upper film section such that an elastically deformable body with the gas-guiding chamber is formed that is enclosed in a gas-tight manner at the top and bottom by the film sections, and the gas-tightly connected film sections between the lateral receiving regions lie flat on top of one another and/or one above the other, at least in part,
wherein at least one of the film sections is connected to first securing means, said first securing means running, in certain regions or continuously, at least on those receiving regions that are disposed on the opposite sides of the strip aerator, for connecting the strip aerator to the retaining elements,
wherein the gas-guiding chamber is free from supporting bodies and/or supporting structures upon which the film sections can rest in or outside of operation of the strip aerator and/or on which the film sections are retained,
wherein said first securing means are designed as a rod- or strip-shaped piping (Keder) and have a round, oval, rectangular or square cross-section, or are designed as mounting rails in the shape of a C profile or a piping profile.

2. The strip aerator according to claim 1, wherein said at least one upper film section and said at least one lower film section are designed as one piece and merge in the lateral receiving regions (15), or are designed as two pieces and joined laterally.

3. The strip aerator according to claim 2, wherein said at least one upper film section and said at least one lower film section are joined laterally, i.e. lengthwise and/or on the face side, in a gas-tight manner, by positive locking and/or friction locking or by means of adhesive bonding, welding, pressure die-casting or extruding in a joining region.

4. The strip aerator according to claim 1, wherein said at least one upper film section and said at least one lower film section are made from the same or from different materials, said at least one upper film section and said at least one lower film section exhibit the same or different degree(s) of hardness.

5. The strip aerator according to claim 1, wherein said first securing means are attached to the lateral receiving regions by extrusion, adhesive bonding, flange-mounting or at least one of the film sections is deformed on its edge in the way of a loop such that a laterally disposed and extended receiving region is formed which surrounds the first securing means at least in part thereby retaining it, where the film section deformed on its edge in the way of a loop forms a receiving region which is connected to or separate from the gas-guiding chamber.

6. The strip aerator according to claim 1, wherein said at least one upper film section and said at least one lower film section are joined in a gas-tight manner at least at a face side and/or at a longitudinal side by means of an end profile.

7. The strip aerator according to claim 1, wherein in said at least one upper film section and/or in said at least one lower film section and/or at least at one face side between said at least one upper film section and said at least one lower film section a through-opening is arranged which is connected to the inlet channel, for example a pipe, preferably via a connecting channel, said connecting channel and/or said inlet channel in the region of the through-opening being attached to at least one of said film sections by positive locking and/or friction locking.

8. An aerator arrangement comprising the at least one strip aerator according to claim 1 as well as comprising at least one retaining element, said at least one strip aerator being attached to said at least one retaining element via said receiving regions running at least on opposite sides of the strip aerator such that the gas-tightly connected film sections of said at least one strip aerator between the lateral receiving regions lie flat on top of one another and/or one above the other, at least in part,
said retaining element comprising second securing means, in which the strip aearator is received in a slideable manner via said first securing means, where said first securing means being arranged laterally on the extended receiving regions,
where said first securing means are designed as a rod- or strip-shaped piping (Keder) and have a round, oval, rectangular or square cross-section, or are designed as mounting rails in the shape of a C profile or a piping profile,
said first securing means being received in a slideable manner in second securing means designed in a corresponding complementary manner.

9. The aerator arrangement according to claim 8, wherein said retaining element is a retaining plate to which said second securing means are affixed.
